(19) United States
(12) Patent Application Publication
(10) Pub. No.: US 2004/0133818 A1
(43) Pub. Date: Jul. 8, 2004

(54) Method for changing the mode of a card, a system, a card, and a device

(75) Inventors: Kimmo Mylly, Julkujarvi (FI); Juha Liinamaa, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/688,273

(22) Filed: Oct. 17, 2003

(30) Foreign Application Priority Data
Oct. 18, 2002 (FI) FI 20021867

(51) Int. Cl. G06F 1/26; G06F 1/28; G06F 1/30

(52) U.S. Cl. 713/300

(57) ABSTRACT

The present invention relates to a method for changing the mode of a card (13) connected to the interface (11) of a terminal (1). The card (13) is provided with at least one dormant mode and a normal mode. In the method, a command to set the normal mode is transmitted to the card (13) to change the mode of the card from said at least one dormant mode to the normal mode. The card (13) generates an interrupt request relating to the change in the mode of the card (13), to be transferred via the interface (11) at the stage when the card (13) has shifted to the normal mode, wherein the interrupt request coming from the card (13) and relating to the mode change is processed in the terminal (1). The invention also relates to a system in which the method is applied. Furthermore, the invention relates to a terminal (1) and a card (13) to be used in the system.

### CROSS-REFERENCE TO RELATED APPLICATIONS

This application claims priority under 35 USC §119 to Finnish Patent Application No. 20021867 filed on Oct. 18, 2002.

### FIELD OF THE INVENTION

The present invention relates to a method for changing the mode of a card connected to the interface of a terminal, the card comprising at least one dormant mode and a normal mode, in which method a command for setting the normal mode is transferred to the card for changing the mode of the card from said at least one dormant mode to the normal mode. The invention also relates to a system comprising a terminal and a card which can be connected to the interface of the terminal and which comprises at least one dormant mode and a normal mode, and which system comprises means for transferring a command for setting the normal mode to the card for changing the mode of the card from said at least one dormant mode to the normal mode. The invention also relates to a card which is arranged to be connected to the interface of a terminal, and which card comprises at least one dormant mode and a normal mode, and means for processing a command to set the normal mode, coming via the interface of the terminal, for changing the mode of the card from said at least one dormant mode to the normal mode. Furthermore, the invention relates to a terminal with an interface for connecting a card to the terminal, which card comprises at least one dormant mode and a normal mode, and which terminal comprises an interface for transferring a command to set the normal mode to the card for changing the mode of the card from said at least one dormant mode to the normal mode.

In this description, a terminal refers to an electronic device which is intended for use as a communication device in connection with a communication network and which terminal comprises data processing functions. Non-restrictive examples of terminals to be mentioned in this context include computers, such as PC devices, portable computers and palmtop computers provided with communication means (e.g. a modem, a network adapter, or the like), wireless communication devices, such as mobile communication devices, and personal digital assistants connected to a mobile communication device or another telecommunication terminal.

### BACKGROUND OF THE INVENTION

There are terminals known which comprise an interface for connecting a card (an interface card or the like) to the terminal. Such a card may be, for example, a memory card for increasing the storage capacity of the terminal, for installing applications in the terminal, etc. The card may also be an interface card intended for data transmission, such as a modem, a network adapter, or the like. Particularly cards used in connection with portable terminals often comprise at least two different modes, of which one is a dormant mode and the other is the normal mode. Thus, when the card is set in the dormant mode, some of the functions of the card are inactivated, for example to reduce the power consumption of the card. There may also be several such dormant modes, wherein a different number of functions may be inactive in the different dormant modes. In the normal mode, all the functions of the card are generally available.

The mode of the card is normally changed from the normal mode to a dormant mode, for example, in such a way that the terminal transfers a given command via the interface to the card, which command is received and interpreted in the card. On the basis of this command, the card changes the mode of the card from the normal mode to the dormant mode indicated in the command. Thus, the card switches off the functions corresponding to the selected dormant mode or sets some of the functions of the card to a sleep state, for example a power saving state. For example, the card may comprise a processor which can be set to a dormant state in which most functions of the processor are inactive.

Correspondingly, the mode of the card is returned from a dormant mode to the normal mode on the basis of e.g. a command, wherein the terminal transfers, via the interface, a command which is received and interpreted on the card. After this, the card initiates the steps to return the normal mode.

The mode of the card is not changed without a delay, wherein the terminal must wait for the change of the mode. This delay may vary among different types of cards and even among cards by different manufacturers. For example, in memory card applications, it is possible to use a variety of memory technologies, such as NAND, NOR, or even a fixed disk, which take different times to change the mode. In such a memory card, it is possible to store e.g. ringing tones for a mobile communication device, logos, application software, etc. In solutions of prior art, the terminal is not informed directly by the card that the card has shifted to the normal mode. Thus, the terminal must either wait for a predetermined maximum time, in which the mode of the card must be changed, or the terminal must transmit inquiries to the card at intervals until the card informs that it is in the normal mode. The setting of a given maximum time will cause that even if a card were faster to change its mode, the terminal cannot detect this but it must always wait for the maximum time. Thus, the functioning may be very slow in connection with a mode change. Furthermore, this alternative involves the problem that some cards may be even slower, wherein such a card is not yet in the normal mode after the expiry of the maximum time. This may cause error situations, and the terminal may even determine that the card is defective. The alternative in which the terminal transmits inquiries to the card at intervals, involves for example the drawback that unnecessary commands are transferred between the terminal and the card and, on the other hand, that the transmission of such inquiries loads the terminal and even increases its power consumption. The loading can be reduced to some extent by prolonging the interval of transmitting inquiries, but in this case the detection of the normal mode of the card is not necessarily so rapid, particularly if the normal mode is activated relatively soon after the transmission of the inquiry message.

### SUMMARY OF THE INVENTION

It is an aim of the present invention to provide an improved arrangement in which the change in the mode of the card from the dormant mode to the normal mode can be detected in the terminal with as short a delay as possible and without the need to send recurrent inquiries relating to the mode from the terminal to the card. The invention is based on the idea that the card transmits an interrupt request to the terminal at the stage when the card has been switched to the normal mode. Thus, the terminal can detect this interrupt request and start to use the card in the normal way. In the solution according to an advantageous embodiment of the invention, a data line is used as the interrupt line, wherein there is no need to arrange a separate interrupt line. To put it more precisely, the method according to the present invention is primarily characterized in that the card generates an interrupt request relating to the change in the mode of the card, to be transmitted via the interface to the terminal at the stage when the card has been set to the normal mode, wherein the interrupt request, which came from the card and which relates to the mode change, is processed in the terminal. The system according to the present invention is primarily characterized in that the system comprises means for generating an interrupt request relating to a change in the mode of the card and for transferring it via the interface from the card to the terminal, and that the terminal comprises an interrupt processor for processing the interrupt request which came from the card and which relates to the mode change. The card according to the present invention is primarily characterized in that the card comprises means for generating an interrupt request relating to the change in the mode of the card. Furthermore, the terminal according to the present invention is primarily characterized in that the terminal comprises means for transferring the interrupt request, relating to the mode change and generated by the card, via the interface from the card to the terminal, and that the terminal comprises an interrupt processor for processing the interrupt request which came from the card and which relates to the mode change.

The arrangement according to the present invention shows remarkable advantages over solutions of the prior art. In the application of the method according to the invention, it is possible to detect the restoration of the normal mode of the card in the terminal without significant delays, wherein the terminal can start to use the card as soon as possible after the change of the mode. This is an important feature in most applications, such as in connection with memory cards, in which information needed by the terminal is stored on the memory card. For example, when the present invention is applied, the terminal can sufficiently quickly retrieve the definitions of a ringing tone indicating an incoming call from a memory card connected to the terminal. Consequently, it is not necessary to set, in the terminal, a maximum time which the terminal must wait until the card is used, as in arrangements of the prior art. Thus, the terminal will not require a timer for this purpose either. Moreover, the terminal does not need to transfer continual inquiries to the card to find out the mode of the card. This will reduce the loading of the terminal and the need to transfer commands from the terminal to the card.

In the application according to an advantageous embodiment of the invention, the data line is used for the transmission of the interrupt request, wherein no separate interrupt line will be needed between the card and the terminal. This will simplify the implementation of the interface.

### DESCRIPTION OF THE DRAWINGS

In the following, the present invention will be described in more detail with reference to the appended drawings, in which

FIG. 1 shows a system according to a preferred embodiment of the invention in a simplified block diagram,

FIG. 2a illustrates a message structure which may be used for changing the mode of the card to the dormant mode in the method according to an advantageous embodiment of the invention,

FIG. 2b illustrates, correspondingly, a message structure that may be used for returning the mode of the card from the dormant mode to the normal mode in the method according to an advantageous embodiment of the invention, and

FIG. 3 shows, in a simplified manner, the interrupt arrangement implemented in a terminal according to a preferred embodiment of the invention.

### DETAILED DESCRIPTION OF THE INVENTION

In the following description of an advantageous embodiment of the invention, a terminal will be exemplified with a wireless terminal 1, but it will be obvious that the invention is not limited to use in such terminals only. The terminal 1 comprises a processor 2, a memory 3, which may also comprise several different memory blocks, such as a read only memory (ROM) and a random access memory (RAM). Furthermore, a part of the memory can be a non-volatile memory, such as an EEPROM memory, in a way known as such. Furthermore, the terminal preferably comprises a display 4, a keypad 5, and audio means, such as an earpiece and/or a speaker 6 and a microphone 7. Preferably, the terminal 1 also comprises communication means, such as a transmitter 9 and a receiver 8, for data transmission between the terminal 1 and a communication network 10. These communication means 8, 9 are preferably intended for wireless communication, wherein the communication network 10 comprises a wireless communication network, such as a mobile communication network, a wireless local area network, or the like. Furthermore, the terminal comprises an interface 11 provided with, for example, a card connection 12 for connecting a card 13 to the terminal 1, as well as a card control unit 14 and a data transmission bus 15 for the transfer of commands and data between the terminal 1 and the card 13. The interface 11 may also comprise more than one bus, wherein also more than one card may be connected to the interface 11 at a time.

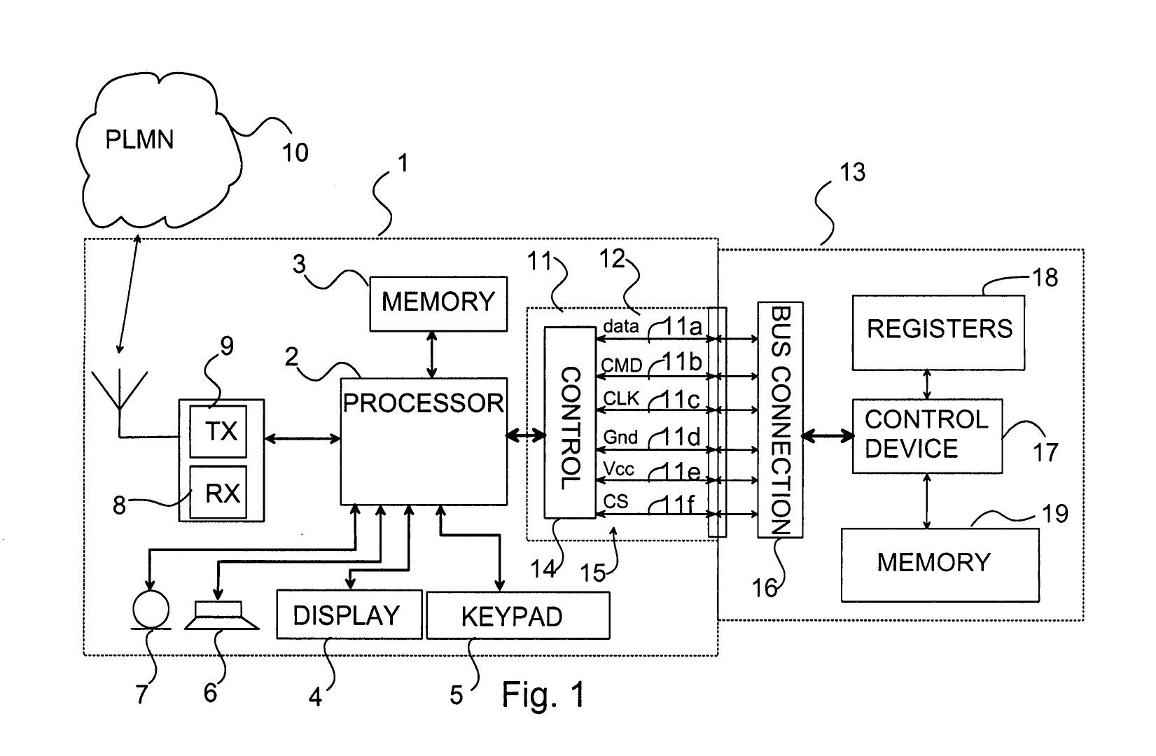

In various applications, the card 13 to be connected to the terminal 1 may be very different, and the present invention is not limited to any specific card. Some non-restrictive examples to be mentioned of such cards 13 include memory cards, such as a memory card complying with the specifications of a MultiMediaCard, communication cards, such as cards comprising mobile communication functions, etc. In the use of the various card types, the terminal interface 11 may vary, but a person skilled in the art will be able to apply the invention in also other interfaces on the basis of the following example application. In the system according to an advantageous embodiment of the invention, shown in FIG. 1, the card is a memory card complying with the MultiMediaCard specifications, and the data transfer between the card 13 and the card control unit 14 of the terminal 1 takes place in serial format according to the MultiMediaCard specifications. In this case, the interface 11 is preferably provided with at least a serial data line 11a, a command line 11b, a clock line 11c, one or more ground lines 11d (Gnd) set to the zero potential, and one or more operating voltage lines 11e (Vcc). In addition, the interface 11 may comprise a chip select line 11f (CS).

FIG. 1 also shows the internal structure of one such card 13 in a simplified block diagram. The card 13 comprises a bus connection block 16, via which the lines of the communication bus 15 are connected to the card 13, a control unit 17 for controlling the functions of the card 13, and a boot block, by means of which the card 13 can be booted in a controlled manner, for example, when the operating voltages are switched on the card, and also under the control of the terminal 1, if necessary. Preferably, the card 13 also comprises internal registers 18 for storing some data. As the card 13 used here as an example is a memory card, the card 13 is also provided with a memory 19 which can be a read only memory and/or a random access memory. The memory 19 may comprise one or more memory types, such as a dynamic memory (DRAM), a static memory (SRAM), or a non-volatile memory (EEPROM, Flash). The memory 19 may also be implemented wholly or partly as a magnetic and/or optic memory, of which nonrestrictive examples include a fixed disk, a CD-ROM, and a digital versatile disk. Furthermore, the card 13 preferably comprises a clock circuit for generating clock signals required in the operation of the different functional blocks of the card 13 in a way known as such.

In this advantageous embodiment of the invention, the functions of the card are preferably controlled in the following way. When the terminal 1 is turned on and the card 13 is connected to the card connection 12, so-called configuration functions are performed in the card 13 in a way known as such, to set the card in a given mode. These configuration functions may also be started under the control of the terminal 1. After the card 13 has been turned on and set, for example, in the normal mode, it is possible to start data transmission between the card 13 and the terminal 1. For the data transmission, the card control unit 14 transmits the clock signal via the clock line 11c to the card 13. In the card 13, this clock signal is used for reading data from the data line 11a. Of the information to be transmitted to the card, the card control unit 14 sets the state of one bit at a time to the data line 11a, wherein the card 13 reads the state of the data line 11a preferably in connection with a state change of the clock line 11c in a given direction, for example when the state of the clock line 11c is changed from the 0 state to the 1 state. The data of the next bit is set to the data line after the above-mentioned change of state of the clock line 11c, wherein the next bit can be read when the state of the clock line 11c is changed for the next time in the corresponding direction. It should be evident that the reading can also be performed for each state change, wherein the new data is always set in the data line before the next state change.

After the transfer of the required number of bits (e.g. 8, 16, 32 or 64 bits), the received data is processed on the card 13. This may involve, for example, a command word, such as a command to reset the function of the card, the writing of data in the memory 19 of the card 13, the reading of data from the memory 19 of the card, or the setting of the mode of the card. Because the present invention relates to the setting of the mode of the card 13, the following description will primarily focus on the commands and other functions relating to the setting of the mode.

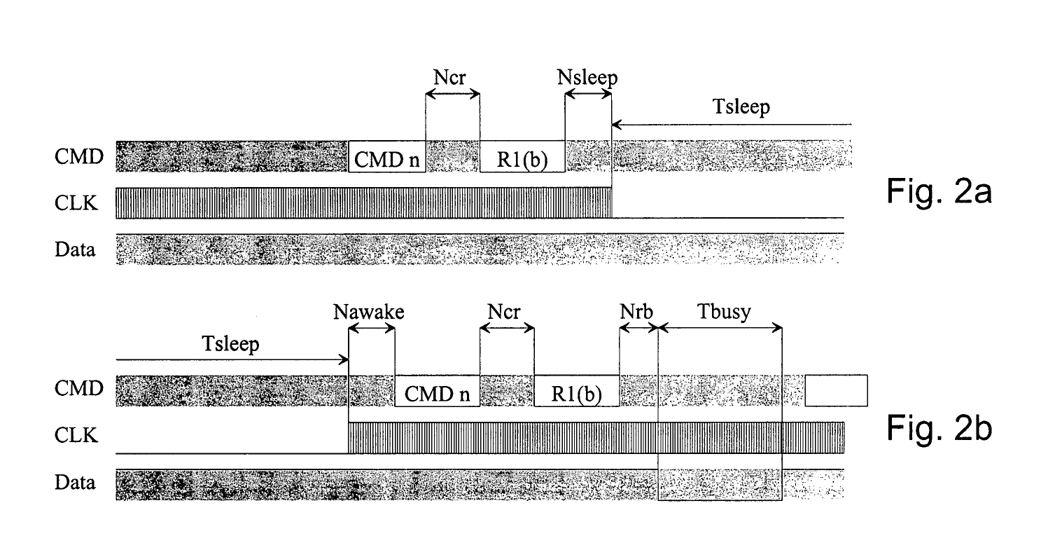

At the stage when the terminal 1 is in a situation in which the card 13 can be set to a dormant mode, the following steps are taken in the method according to an advantageous embodiment of the invention. The terminal 1 generates a command to set the dormant mode and transmits it via the interface 11 to the card 13. FIG. 2a shows the signalling at the interface in connection with the transfer of this command. The terminal 1 generates a clock signal to the clock line 11c. This is illustrated by the line CLK in FIG. 2a. The command (CMD n) is transmitted via the command line 11b to the card (line CMD in FIG. 2a) in serial format preferably so that the most significant bit is transmitted first. However, also another bit transmission order can be applied within the scope of the invention. Also serial transfer of commands is possible within the scope of the invention. In the card 13, the bits relating to the command are received and, for example, stored in a command buffer (not shown). After all the bits of the command (e.g. 32 bits) have been received in the card 13, the command is interpreted in the card. Because the command in question was one to set the card in a dormant mode, the card control unit 17 initiates' the necessary measures to set the card in the dormant mode. Preferably, the card 13 transmits an acknowledgement (response) to the terminal 1 as a sign that the command was received. This is illustrated by the message R1(b) on the first line in FIG. 2a. The length of the acknowledgement is, for example, 48 bits, but also messages of other lengths can be used. Preferably, it is assumed in the terminal 1 that the card 13 must respond to the command within a prescribed time. This time limit is illustrated by the reference Ncr in connection with the first line in FIG. 2a. If the terminal 1 does not receive a response within this time limit, the terminal 1 may attempt retransmission of the command. If the terminal 1 does not receive a response from the card 13 after several attempts, it is assumed that the card 13 is defective.

In a situation in which the terminal 1 receives the acknowledgement R1(b) from the card 13, it is assumed that the card will shift to the dormant mode within a prescribed time. So that the card 13 will have sufficient time to take the necessary steps to shift to the dormant mode, the electronic device 1 continues to transmit clock pulses to the card 13 preferably for at least this time required for shifting to the dormant mode. This time is marked with the reference Nsleep on the first line of FIG. 2a. The card 13 may also shift to the dormant mode sooner than in this time limit. In this advantageous embodiment of the invention, no clock pulses are transmitted to the card 13 when the card is in the dormant mode.

At the stage when the terminal 1 detects a need to shift the card 13 from the dormant mode to the normal mode, at least the following steps are taken in an advantageous embodiment of the invention. FIG. 2b shows corresponding signalling at the interface in connection with the shift to the normal mode. The terminal 1 starts to transfer clock pulses to the clock line 11c and still waits for a prescribed time so that the control unit 17 of the card 13 will have time to start its own operation to be ready to receive commands from the terminal 1. If the control unit 17 itself comprises one or more dormant modes in addition to the normal mode, the control unit is set to the normal mode after the beginning of the transmission of the clock signal in the clock line 11c. The time required for starting the card 13 may vary for different cards, but it is assumed here that a maximum time Nawake has been set, within which the card must be ready to receive commands. After the expiry of this maximum time Nawake, the terminal 1 transmits, via the command line 11b, the command CMD n to start the normal mode for the shifting of the card to the normal mode. The terminal 1 remains waiting for a response which should come within the prescribed time Ncr, as presented in connection with the setting of the dormant mode. After the card 13 has received the command, the control unit 17 interprets it and initiates the measures to set the card to the normal mode. Thus, the control unit preferably generates a response R1(b) and transmits it via the interface 11 to the terminal 1. Furthermore, the control unit starts its internal functional blocks.

At the stage when the card is in the normal mode, an interrupt request is generated to be transmitted to the terminal 1. This interrupt request can be transmitted either via a separate interrupt line (not shown) or by another suitable method. In an advantageous embodiment of the present invention, the data line 11a is used for this transfer of the interrupt request. Thus, the following steps are taken. The card control unit 17 sets the data line in a given logical state, such as the 0 state, after the card 13 has transmitted the response R1(b) to the terminal 1. It is assumed that the time between the transmission of the last bit of the response and the setting of the state of the data line is, at a maximum, the time which is indicated with Nrb in FIG. 2b. If the mode change is not completed within this time, the terminal 1 may, for example, presume that the card is not in working order. In such a situation, the terminal 1 may also attempt to boot the card 13. However, it should be evident that the interrupt line or other means suitable for the transfer of the interrupt request from the card to the terminal do not necessarily need to be arranged in connection with said bus connection 11 in the terminal 1, but they can also be implemented in connection with another connection of the terminal or even as separate connections arranged in the terminal for this purpose. In some applications, the interrupt request can also be transferred partly by applying a wireless communication method, such as by optical signal transmission.

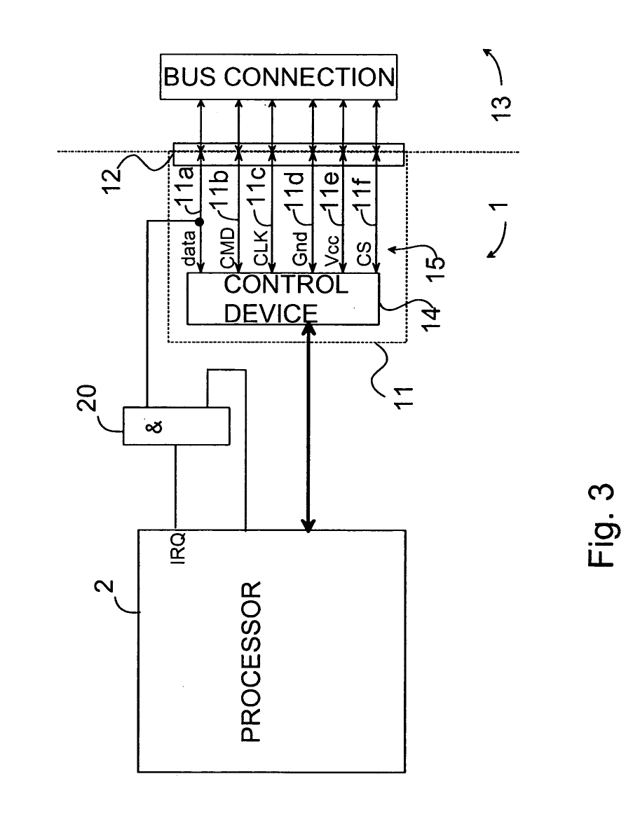

If the card 13 is in working order and it sets the data line in said 0 state within the prescribed time Nrb, the operation is preferably continued as follows. The card continues to take the measures required for setting the normal mode, until the card 13 has been set in the normal mode. After this, the card 13 changes the state of the data line to another specific logical state, which in this example is the 1 state. This state shift from the 0 state to the 1 state is detected in the terminal 1, whereby the terminal 1 determines that the card has shifted to the normal mode, wherein the normal operation can be continued. The use of the data line in the terminal 1 can be implemented, for example, in the way shown in FIG. 3. In connection with the command to start the normal mode, for example the processor 2 of the terminal sets the first input of a port 20 in the logical 1 state. Thus, the state of the second input of the port 20 is shifted to the output of the port 20, which, in turn, is coupled to an interrupt input IRQ of the control unit. The program commands necessary for the interrupt process are implemented in the program code of the terminal control unit 14. When the first input of the port 20 is in the logical 0 state, changes in the state of the data line will have no effect on the state of the output of the port 20, wherein no interrupts will be generated either. The way in which the interrupt can be detected in the terminal 1 is known as such by a person skilled in the art, wherein its description in more detail will not be necessary in this context. It should also be mentioned that the above-presented embodiment example is only one possible way of implementing interrupt requests.

Although the invention was described above in such a way that the card transmits a response to the command to start the normal mode, the invention can also be applied in such a way that no such response is transmitted from the card. In this case, after receiving the command, the card starts the measures to set the normal mode and forms an interrupt request after the normal mode has been set. On the basis of the interrupt request, the terminal 1 detects that the card has returned to the normal mode.

By the above-described method, it is thus possible to accelerate the operation of the system in connection with mode changes, because the terminal 1 does not need to wait for the maximum time if the card is started faster than that. Thus, the maximum time can be set to a relatively long time, within which the card should shift to the normal mode, irrespective of the technology used in the implementation of the card. If the card does not generate an interrupt request even within this maximum time, it can be assumed that the card is defective and, for example, booting of the card may be attempted. The maximum time can thus be used to prevent that the terminal 1 does not remain, for an indefinite time, waiting for the starting of the normal mode of the card in a case when it is not possible.

In the foregoing, the use of the same command word CMD n was presented in the setting of both the dormant mode and the normal mode. Thus, different bits of the command word can be given a specific meaning, and the card may examine these bits to find out the command in question each time. For example, the most significant bit may indicate whether it relates to the setting of the dormant mode or the normal mode. The command used to set the dormant mode may comprise the time during which the card 13 should stay in the dormant mode and after which it should shift to the normal mode. Thus, the restoration of the normal mode is not necessarily needed, unless the terminal 1 detects a need to shift the card to the normal mode earlier than the set time, or unless the time parameter used in the setting of the dormant mode indicates a time during which the card is in such a dormant mode that the card is not capable of receiving commands.

Although a situation was described above, in which the card was set in only one dormant mode, it should be evident that the invention can also be applied in systems in which the card has more than one dormant mode (for example, a standby mode and a sleep mode). In such a case, the command used for setting the dormant mode preferably indicates the dormant mode in which the card is to be set. These methods for shifting the card to a dormant mode are known as such for a person skilled in the art. For restoring the normal mode, the above-presented inventive principles can be applied.

It should also be evident that the present invention is not limited solely to the above-presented embodiments but it can be modified within the scope of the appended claims.

1. A method for changing a mode of a card connected to an interface of a terminal, which card comprises at least one dormant mode and a normal mode, in which method a command for setting the normal mode is transmitted to the card to change the mode of the card from said at least one dormant mode to the normal mode, the card generates an interrupt request related to the change in the mode of the card, to be transmitted via the interface to the terminal at the stage when the card shifts to the normal mode, wherein the interrupt request, received from the card and relating to the mode change, is processed in the terminal.

2. The method according to claim 1, wherein the interface is provided with one or more signal lines, wherein one of said signal lines of the interface is used for transferring said interrupt request to the terminal.

3. The method according to claim 2, wherein a state of the signal line used for the transfer of said interrupt request is set in a first logical state after the command to set the normal mode has been received in the card, and that the state of the signal line used for the transfer of said interrupt request is set in a second logical state after the normal mode is in use in the card.

4. The method according to claim 2, wherein at least one of said signal lines is a data line, and that said interrupt request is transmitted on said data line.

5. The method according to claim 1, wherein after receiving said command to set the normal mode, an acknowledgement about the reception of the command is transmitted from the card to the terminal.

6. The method according to claim 1, wherein said terminal used is a wireless terminal provided with mobile station functions.

7. A system comprising a terminal and a card which can be connected to an interface of the terminal and which card comprises at least one dormant mode and a normal mode, and which system comprises means for transferring a command to set the normal mode to the card, for changing the mode of the card from said at least one dormant mode to the normal mode, and means for generating an interrupt request relating to the change of the mode and for transferring it via the interface from the card to the terminal, and that the terminal comprises an interrupt processor for processing the interrupt request which has come from the card and which relates to the mode change.

8. The system according to claim 7, wherein the interface is provided with one or more signal lines, wherein one of said signal lines of the interface is arranged to be used for transferring said interrupt request to the terminal.

9. The system according to claim 8, wherein a state of the signal line used for the transmission of said interrupt request is arranged to be set in a first logical state after the command to set the normal mode has been received in the card, and that a state of the signal line used for the transfer of said interrupt request is arranged to be set in a second logical state after the normal mode is in use in the card.

10. The system according to claim 8, wherein at least one of said signal lines is a data line, and that said interrupt request is arranged to be transferred on said data line.

11. The system according to claim 8, the interface comprising at least one card connection for connecting a card to the terminal, and said at least one card connection comprising at least the following lines:
one data line for the transfer of data between the terminal and the card,
one command line for the transmission of commands from the terminal to the card and for the transmission of responses from the card to the terminal, and
one clock line for the transmission of a clock signal from the terminal to the card.

12. The system according to claim 7, wherein after receiving said command to set the normal mode, an acknowledgement about the reception of the command is arranged to be transmitted from the card to the terminal.

13. A card which is arranged to be connected to an interface of a terminal and which card comprises at least one dormant mode and a normal mode and means for processing a command to set the normal mode, said command coming via the interface of the terminal, for changing the mode of the card from said at least one dormant mode to the normal mode, and means for generating an interrupt request relating to the change in the mode of the card.

14. The card according to claim 13, comprising means for transferring the interrupt request via the interface of the terminal to the terminal.

15. The card according to claim 13, wherein the interface is provided with one or more signal lines, wherein the card comprises a bus connection block for transferring said interrupt request to the terminal on one of said signal lines of the interface.

16. A memory card which is arranged to be connected to an interface of a terminal and which memory card comprises at least one dormant mode and a normal mode and means for processing a command to set the normal mode, said command coming via the interface of the terminal, for changing the mode of the memory card from said at least one dormant mode to the normal mode, and means for generating an interrupt request relating to the change in the mode of the memory card.

17. A terminal provided with an interface for connecting a card to a terminal, which card comprises at least one dormant mode and a normal mode, and which terminal comprises an interface for transferring a command to set the card in the normal mode, for changing the mode of the card from said at least one dormant mode to the normal mode, wherein the terminal comprises means for transmitting an interrupt request, relating to the mode change and generated by the card, via the interface from the card to the terminal, and that the terminal comprises an interrupt processor for processing the interrupt request coming from the card and relating to the mode change.

18. The terminal according to claim 17, wherein the interface is provided with one or more signal lines, that at least one of said signal lines is a data line, and that said interrupt request is arranged to be transferred on said data line, wherein the terminal comprises a coupling block for transferring the interrupt request from said data line to said interrupt processor.

19. A mobile station provided with an interface for connecting a card to a mobile station, which card comprises at least one dormant mode and a normal mode, and which mobile station comprises an interface for transferring a command to set the card in the normal mode, for changing the mode of the card from said at least one dormant mode to the normal mode, wherein the mobile station comprises means for transmitting an interrupt request, relating to the mode change and generated by the card, via the interface from the card to the mobile station, and that the mobile station comprises an interrupt processor for processing the interrupt request coming from the card and relating to the mode change.
